(19) United States
(12) Patent Application Publication
(10) Pub. No.: US 2010/0006494 A1
(43) Pub. Date: Jan. 14, 2010

(54) BIO-RESISTANT FILTER COALESCER CARTRIDGE

(76) Inventors: Joan Scher, Sylacauga, AL (US); David Stanley Hawkins, Colorado Springs, CO (US); Gregory S. Sprenger, Colorado Springs, CO (US); Rob Perkins, Sylacauga, AL (US)

Correspondence Address: FRASER CLEMENS MARTIN & MILLER LLC, 28366 KENSINGTON LANE, PERRYSBURG, OH, 43551, US

(21) Appl. No.: 12/171,361

(22) Filed: Jul. 11, 2008

(51) Int. Cl. B01D 29/23; B01D 29/50

(52) U.S. Cl. 210/484; 210/487; 156/148

(57) ABSTRACT

A filter coalescer cartridge for treating jet fuels is disclosed. The filter coalescer cartridge has spaced apart filter/coalescer layers to effectively remove particulate contaminates and water from the transient fuel being treated. The outer most layer is a knitted sock material formed from cotton threads including a metallic silver disposed thereon to provide an anti-microbial property to the sock material.

### FIELD OF THE INVENTION

The present invention relates to filter coalescer cartridges, and more particularly to filter coalescer cartridges including filter and coalescer media with anti-microbial properties.

### BACKGROUND OF THE INVENTION

Filter coalescer cartridges are typically a critical component of jet fuel refueling filtration equipment. The filter coalescer cartridges are employed to capture solid contaminants, and to coalesce water that may be present in the fuel. Such a filter coalescer cartridge is disclosed in commonly owned U.S. Pat. No. 6,569,330, hereby incorporated herein by reference in its entirety.

State of the art filter coalescer elements typically contain a plurality of media sections adapted to facilitate the capture of solid contaminants and the coalescence of water that may be present in the fuel. Historically, the outermost media section has been an outer cotton knit sock formed from woven unbleached cotton fibers. The chemistry and fiber morphology of unbleached cotton provides desirable water droplet growth properties to the outermost media section of the filter coalescer.

Although the natural unbleached cotton fiber provides the desired water droplet growth properties, the cotton fibers have poor anti-microbial properties. Microbes are known to be present and to grow in water and hydrocarbons. Additionally, the cotton fibers are a source of food for the microbes which typically attach to the cotton fibers and grow thereon. Over time the microbes can grow and consume the cotton fibers making it necessary to replace the outer cotton knit sock, or the entire filter coalescer cartridge, to maintain a desired performance of filter coalescer cartridge.

One method commonly employed to inhibit the growth of microbes on the cotton fibers of the knit sock has been to treat the cotton with an anti-microbial compound such as a boron or an arsenic based chemical compound, for example. However, the anti-microbial compounds are typically either water or hydrocarbon soluble and, therefore, are dissolved and rinsed from the cotton fibers during service. Accordingly, the anti-microbial protection for the cotton knit-sock is lost during service which reduces the service life of the cotton knit-sock.

It would be desirable to produce a new and improved filter coalescer having an outer sock with imbedded anti-microbial properties to extend the service life of the filter coalescer.

### SUMMARY OF THE INVENTION

Compatible and attuned with the present invention, a new and improved filter coalescer having an outer sock with imbedded anti-microbial properties to extend the service life of the filter coalescer, has surprisingly been discovered.

In one embodiment, a filter coalescer cartridge for treating jet fuel comprises a pleat block assembly; a fiber wrap surrounding the pleat block assembly; and a knitted sock material surrounding at least the fiber wrap, the knitted sock material including a metallic silver to provide an anti-microbial property to the sock material.

In another embodiment, a filter coalescer cartridge for treating jet fuel comprises a pleat block assembly; a fiber wrap surrounding the pleat block assembly including a first glass fiber layer having an inner and an outer surface, a second glass fiber layer having an inner and an outer surface surrounding the outer surface of the first glass fiber layer, and a fluid pervious support layer surrounding the outer surface of the second glass fiber layer; and a knitted sock material surrounding at least the fiber wrap, the knitted sock material formed form a plurality of cotton threads woven together, the threads including at least one plastic filament having metallic silver particles disposed thereon to provide an anti-microbial property to the sock material.

In another embodiment, a process for forming a filter coalescer for treating jet fuel comprises forming a pleat block assembly; forming a fiber wrap surrounding the pleat block assembly; and forming a knitted sock material surrounding at least the fiber wrap, the knitted sock material formed form a plurality of cotton threads woven together, the threads including at least one plastic filament having metallic silver particles disposed thereon to provide an anti-microbial property to the sock material.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross-sectional view of a filter coalescer cartridge containing the features of the present invention;

FIG. 2 is an enlarged fragmentary view of a portion of the cartridge illustrated in FIG. 1;

FIG. 3 is a cross-sectional view of a modified form of the filter coalescer cartridge illustrated in FIGS. 1 and 2; and

FIG. 4 is an enlarged fragmentary view of a portion of the cartridge illustrated in FIG. 3.

### DETAILED DESCRIPTION OF THE PREFERRED EMBODIMENTS OF THE INVENTION

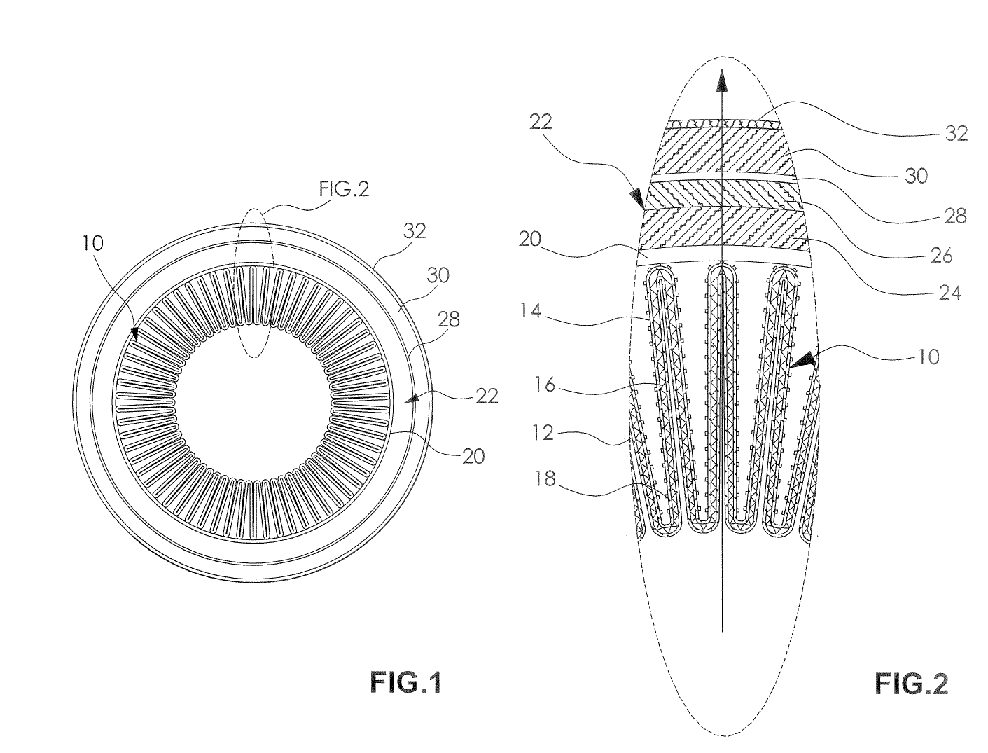

Referring to FIGS. 1 and 2 there is illustrated a filter coalescer cartridge design to treat hydrocarbon fluids such as, for example, JP8+100 jet fuel. The filter coalescer cartridge has a generally cylindrical shape and is designed for an inside-out flow of the fluid being treated. The filter coalescer cartridge includes a pleat block 10 containing a first layer 12 of pleated filter media having oppositely disposed facing surfaces. The pleated filter layer 12 is formed in an annular arrangement wherein the individual pleats are parallel with one another.

A second layer 14 of pleated filter media having oppositely disposed facing surfaces in disposed in spaced relation downstream from the outer facing surface of the first layer 12. The pleated filter media is formed in an annular arrangement wherein the individual pleats are parallel with one another and are spaced apart in the same fashion as the pleats of the first layer 12.

The pleats of the second layer 14 are spaced from pleats in the first layer 12 by a fluid pervious pleated spacer material 16. The spacer material 16 provides a relatively void space between the first layer 12 and the second layer 14. It has been found that satisfactory functional results can be achieved by forming the spacer material 16 of a spacer material supplied by Nalle Plastic of Austin, Tex. and commercially designated as Naltex 37-3821.

A final fluid pervious pleated layer 18 is provided as a support media. The pleated layer 18 is formed of a woven screen material to provide and maintain the desired pleated configuration and to assure consistence of the separation of the pleats formed in the first layer 12, the second layer 14 and the spacer material 16. It has been found that a mesh size in the range of 15-30 mesh (wires/inch) is preferable in the pleated layer 18. Also, high open area (>40%) in the screen of the pleated layer 18 is preferable.

In the preferred embodiment of the invention, the first layer 12 of filter media is formed of a dual layer media which is constructed of two different glass fiber mixes incorporated into one thin unitary media to provide high dirt holding capacity. The second or downstream glass fiber mix contains finer or smaller diameter glass fibers in respect of the first glass fiber mix. The first glass fiber mix containing the more coarse fibers is effective to capture the larger particulate contaminants in the transient fuel being treated, while the second glass fiber mix containing the finer fibers is effective to capture the smaller particulate contaminants in the transient fuel being treated.

Functionally, it has been found that the first or upstream layer 12 functions to mainly capture solid particles, but the media also commences the coalescing process. Due to the stringent particle capacity requirements of such filter coalescer cartridges, the first layer 12 must exhibit very high particle loading capacity (high solids/area of media). Favorable results have been obtained employing a glass fiber media produced by Hollingsworth & Vose Company, East Walpole, Mass. and is commercially designated as DC-4271. The glass fiber is composed of borosilicate glass fibers with an acrylic binder. The acrylic binder content is about 5 by weight.

It has been found that as the first layer 12 captures particles from the transient fuel, the coalescing function of the layer 12 may tend to decrease in efficiency. As the first layer 12 captures more and more particles, the pores in the media become plugged with captured particulates. The velocity of the fluid flow through the remaining open pores tends to increase. Such increase in the velocity of the fluid being treated results in less efficient coalescing. Additionally, the free water in the transient fluid causes the pressure drop across the first layer 12 to rise which, in turn, impairs the coalescence of the water in the transient fluid.

The second layer 14 of filter media is effective to continue the water coalescence process as the fluid being treated passes through the cartridge. The second layer 14 is typically formed of the same filter media as the first layer 12.

The completed filter coalescer of the embodiment illustrated in FIGS. 1 and 2 includes a perforated metal tube 20 which surrounds the pleat block assembly 10. The tube 20 is typically formed of aluminum, approximately 5¼″ ID, with approximately forty (40%) percent open area.

In order to obtain maximum burst strength, it has been found that the openings or perforations in the tube 20 are formed by stamping or otherwise producing louvered-like openings. The outermost surfaces of the radially outer pleats of the support layer 18 are positioned to be in intimate contact with the inner surface of the tube 20.

Next, a layer 22 of glass fiber material is wrapped about the outer surface of the perforated tube 20. The layer 22 is comprised of glass fiber wraps consisting of two media, clearly shown in FIG. 2, both obtained from Johns-Manville Corporation, Denver, Colo. An inner wrap 26 is a 5 HT blanket (approximately one micron diameter glass fiber), ⅜ inch thick, 0.018 lbs/sq.ft., with phenolic binder, vendor P/N LFU4-3/8; an outer wrap 28 is a 22 HT blanket (approximately four and one half micron diameter glass fiber), ¾ inch thick, 0.039 lbs/sq.ft. with phenolic binder, vendor P/N LFU22-3/4. A fluid pervious support screen 28 is provided that surrounds the outer wrap 26.

A layer 30 is formed about the outer surface of the support screen 28. The layer 30 is typically comprised of polyester fibers with a binder. The layer 24 is typically approximately ¼″ thick, and weighs 0.44 ounces per square foot. The material is commercially available under the trademark Hiloft from Hobbs Bonded Fibers, vendor P/N 63H515.

The entire cartridge assembly is disposed within an outer layer 32 formed of a knit material. The outer layer 32 may be formed of a cotton sock material 15 inches wide when fully stretched. The knit material includes metallic silver disposed thereon to provide anti-microbial properties to the outer layer 32. A satisfactory material typically is formed by weaving together a plurality of cotton threads, with some threads having at least one filament including metallic silver particles disposed thereon. Favorable results have been obtained by employing a plastic filament having metallic silver particles embedded thereon and spun with a plurality of cotton filaments to form a composite thread. The material is available commercially from Brecon Knitting Mill, Inc., Talladega, Ala. Additionally, a satisfactory material may have the following properties: 20 wales/inch, 20 courses/inch, and 12.5 yds/lb.

Functionally, it has been found that the metallic silver embedded in the cotton threads provides an anti-microbial property to the cotton outer layer 32. The metallic silver militates against microbes attaching to the cotton fibers, and extends the service life of the outer layer and the associated filter coalescer cartridge.

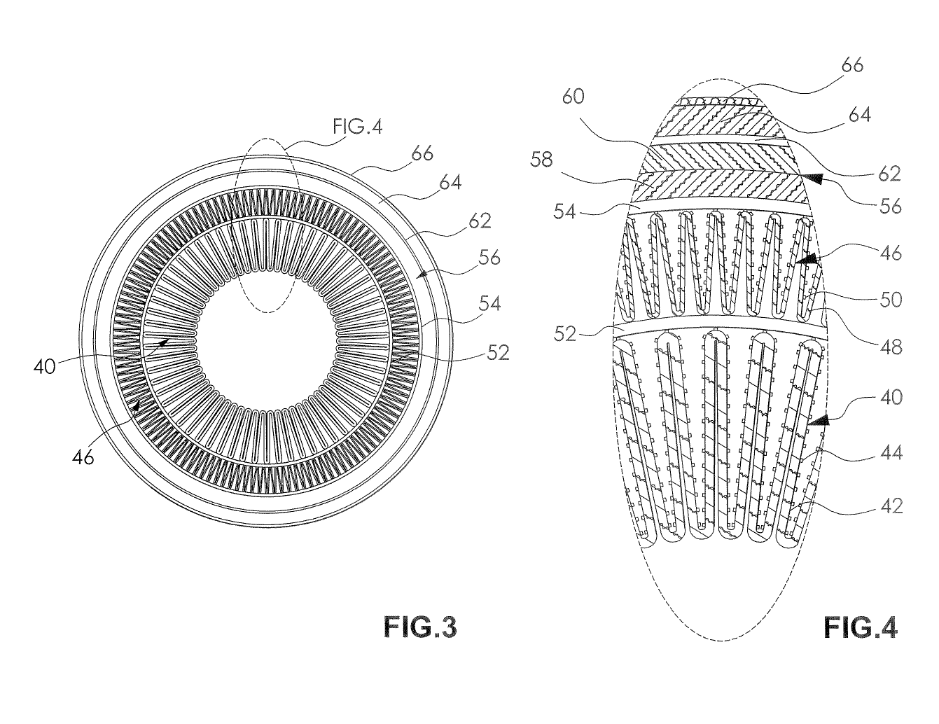

An alternative filter coalescer structure is illustrated in FIGS. 3 and 4. The filter coalescer cartridge has a generally cylindrical shape and is designed for an inside-out flow of the fluid being treated. The illustrated embodiment basically includes two separate pleat blocks 40, 46 which can be successfully used to achieve the same functionality provided by the spacing between the first layer 12 and the second layer 14 formed in pleat block 10 illustrated in FIGS. 1 and 2.

The filter coalescer structure of FIGS. 3 and 4 includes an inside or first pleat block 40 which is comprised of a layer 42 of pleated filter media having oppositely disposed facing surfaces. The pleated filter layer 42 is comprised of a dual layer media constructed of two different glass fiber mixes incorporated into one thin unitary media. A fluid pervious woven mesh support media 44 is disposed in pleated relation on the outer facing surface of the filter layer 42. Satisfactory results have been obtained by utilizing a filter media produced by Hollingsworth & Vose Company, East Walpole, Mass. and commercially available as DC-4271.

An outside or second pleat block 46 contains a layer 48 of pleated glass filter media having opposing disposed facing surfaces. The pleated fiber layer 48 is comprised of a dual layer media constructed of two different glass fiber mixes incorporated into one thin unitary media. The material is available from the same source as the layer 40. A fluid pervious woven mesh support media 50 is disposed in pleated relation on the outer facing surface of the filter layer 48.

A thin metal perforated tube 52, similar in construction to the tube 20 of the embodiment of FIGS. 1 and 2, is interposed between the outermost surfaces of the pleats of the filter layer support media 44 and the innermost surface of the pleats of the filter layer 48 of the pleat block 46. The perforated tube 52 provides additional burst strength to the first pleat block 10.

The completed filter coalescer of the embodiment illustrated in FIGS. 3 and 4 includes a second perforated metal tube 54, similar in construction to the tube 52, which surrounds the pleated assembly of the second pleat block 46. The outermost surfaces of the radially outer pleats of the support media 50 are in intimate contact with the inner surface of the tube 54.

Next, a layer 56 of fiberglass material is wrapped about the outer surface of the perforated tube 54. The layer 56 is comprised of a two media material including an inner wrap 58 and an outer wrap 60, clearly shown in FIG. 4, which is the same as used for forming the wraps 24, 26 in layer 22 of the embodiment of FIGS. 1 and 2. Additionally, a fluid pervious support screen 62 is provided that surrounds the outer wrap 60.

A layer 64 of material is formed about the outer surface of the support screen 62. The layer 64 is typically comprised of polyester fibers which is the same material used for forming the layer 30 of the embodiment of FIGS. 1 and 2.

The entire cartridge assembly is disposed within an outer layer 66 formed of a knit material which may be the same as used in forming the layer 32 of the embodiment of FIGS. 1 and 2.

Due to the extra space needed for the final layer 50 of support media compared with the embodiment illustrated in FIGS. 1 and 2, less filter media can be used in the design. To compensate for the reduced filter media, the heights of the pleat blocks can be different. Increasing the length of the pleats of the first or inner pleat block 40 allows more surface area in the inner pleat block for the capture of solid particulate contaminants. Such design parameters result in an increase in the capacity to capture solid particulates. However, this causes a decrease in the overall inner diameter of the filter cartridge.

An advantage of the embodiment of FIGS. 3 and 4 resides in the fact that any pressure build-up generated by the capture of particles in the first pleat block 40 does not cause compression of the second pleat block 46. Thereby, the effective coalescence of the second pleat block 46 is independent of the pressure build-up of the first pleat block 40.

The embodiment shown in FIGS. 1 and 4 provides anti-microbial properties to the outer layer 32, 64 of the respective filter coalescer cartridges. The anti-microbial properties of the outer layers 32, 64 maximize a service life of the filter coalescer cartridge by substantially eliminating damage to the outer layers 32, 64 caused by microbes attaching to and consuming the cotton fibers forming the outer layers 32, 64.

In accordance with the provisions of the patent statutes, the present invention has been described in what is considered to represent its preferred embodiment. However, it should be understood that the invention can be practiced otherwise than as specifically illustrated and described without departing from its spirit or scope.

What is claimed is:

1. A filter coalescer cartridge for treating jet fuel comprising:
a pleat block assembly;
a fiber wrap surrounding the pleat block assembly; and
a knitted sock material surrounding at least the fiber wrap, the knitted sock material including a metallic silver to provide an anti-microbial property to the sock material.

2. The filter coalescer cartridge according to claim 1 wherein the cartridge has a generally cylindrical shape.

3. The filter coalescer cartridge according to claim 1 wherein the pleat block assembly includes:
a first layer of pleated glass fiber filter media having oppositely disposed facing surfaces formed in an annular array of individual parallel spaced apart pleats;
a second layer of pleated glass fiber filter media having oppositely disposed facing surfaces formed in an annular array of individual parallel spaced apart pleats, the second layer of pleated filter media surrounding the first layer of filter media to form a nested pleated structure such that outer facing peaks of the first layer of media fit within inner valleys of the second layer of media and inner facing peaks of the second media fit within outer valleys of the first layer of media;
a fluid pervious support layer surrounding the outer surface of the second layer of pleated filter media; and
an intermediate spacer layer disposed between the first and second layers of pleated filter media.

4. The filter coalescer cartridge according to claim 3 wherein the first layer and the second layer of filter media are formed of glass fibers of at least two different fiber diameter mixes.

5. The filter coalescer cartridge according to claim 4 wherein one of the fiber diameter mixes is comprised of fibers of one diameter and the fiber diameter of the other of the fiber diameter mixes contains fibers of a greater diameter.

6. The filter coalescer cartridge according to claim 3 wherein the intermediate spacer layer is comprised of a fluid impervious material.

7. The filter coalescer cartridge according to claim 6 wherein the fluid impervious material effectively spaces the pleats of the first layer from the pleats of the second layer of filter media.

8. The filter coalescer cartridge according to claim 1 including a perforated tube surrounding the pleat block assembly.

9. The filter coalescer cartridge according to claim 1 wherein the pleat block assembly includes:
a first pleat block;
a second pleat block disposed adjacent to and surrounding the first pleat block;
a first perforated tube interposed between an outermost surface of the first pleat block and an innermost surface of the second pleat block; and
a second perforated tube surrounding the second pleat block.

10. The filter coalescer cartridge according to claim 9 wherein the first pleat block and the second pleat block are formed from a dual layer media constructed of two different glass fiber mixes incorporated into a unitary media and a screen support layer surrounding an outer surface of the unitary media.

11. The filter coalescer cartridge according to claim 1 wherein the fiber wrap surrounding the pleat block assembly includes:
a first fiber layer having an inner and an outer surface;
a second fiber layer having an inner and an outer surface surrounding the outer surface of the first fiber layer; and
a fluid pervious support layer surrounding the outer surface of the second fiber layer.

12. The filter coalescer cartridge according to claim 11 wherein the inner fiber layer and the outer fiber layer are formed of glass fibers.

13. The filter coalescer cartridge according to claim 1 including a layer of non-woven polyester fiber surrounding the fiber wrap.

14. The filter coalescer cartridge according to claim 1 wherein the knitted sock material is formed form a plurality of cotton threads woven together, a selected quantity of the threads including at least one plastic filament having metallic silver particles disposed thereon.

15. A filter coalescer cartridge for treating jet fuel comprising:
a pleat block assembly;
a fiber wrap surrounding the pleat block assembly including a first glass fiber layer having an inner and an outer surface, a second glass fiber layer having an inner and an outer surface surrounding the outer surface of the first glass fiber layer, and a fluid pervious support layer surrounding the outer surface of the second glass fiber layer; and
a knitted sock material surrounding at least the fiber wrap, the knitted sock material formed form a plurality of cotton threads woven together, a selected quantity of the threads including at least one plastic filament having metallic silver particles disposed thereon to provide an anti-microbial property to the sock material.

16. The filter coalescer cartridge according to claim 15 wherein the pleat block assembly includes:
a first layer of pleated glass fiber filter media having oppositely disposed facing surfaces formed in an annular array of individual parallel spaced apart pleats;
a second layer of pleated glass fiber filter media having oppositely disposed facing surfaces formed in an annular array of individual parallel spaced apart pleats, the second layer of pleated filter media surrounding the first layer of filter media to form a nested pleated structure such that outer facing peaks of the first layer of media fit within inner valleys of the second layer of media and inner facing peaks of the second media fit within outer valleys of the first layer of media;
a fluid pervious support layer surrounding the outer surface of the second layer of pleated filter media; and
a fluid pervious intermediate spacer layer disposed between the first and second layers of pleated filter media.

17. The filter coalescer cartridge according to claim 15 wherein the pleat block assembly includes:
a first pleat block;
a second pleat block disposed adjacent to and surrounding the first pleat block;
a first perforated tube interposed between an outermost surface of the first pleat block and an innermost surface of the second pleat block; and
a second perforated tube surrounding the second pleat block.

18. A process for forming a filter coalescer for treating jet fuel comprising:
forming a pleat block assembly;
forming a fiber wrap surrounding the pleat block assembly; and
forming a knitted sock material surrounding at least the fiber wrap, the knitted sock material formed form a plurality of cotton threads woven together, a selected quantity of the threads including at least one plastic filament having metallic silver particles disposed thereon to provide an anti-microbial property to the sock material.

19. The process of claim 18 including forming the pleat block assembly by:
forming a first layer of pleated glass fiber filter media having oppositely disposed facing surfaces formed in an annular array of individual parallel spaced apart pleats;
forming a second layer of pleated glass fiber filter media having oppositely disposed facing surfaces formed in an annular array of individual parallel spaced apart pleats, the second layer of pleated filter media surrounding the first layer of filter media to form a nested pleated structure such that outer facing peaks of the first layer of media fit within inner valleys of the second layer of media and inner facing peaks of the second media fit within outer valleys of the first layer of media;
forming a fluid pervious support layer surrounding the outer surface of the second layer of pleated filter media; and
forming a fluid pervious intermediate spacer layer disposed between the first and second layers of pleated filter media.

20. The process of claim 18 including forming the pleat block assembly by:
forming a first pleat block;
forming a second pleat block disposed adjacent to and surrounding the first pleat block;
forming a first perforated tube interposed between an outermost surface of the first pleat block and an innermost surface of the second pleat block; and
forming a second perforated tube surrounding the second pleat block.
